(19) United States
(12) Patent Application Publication
(10) Pub. No.: US 2011/0304909 A1
(43) Pub. Date: Dec. 15, 2011

(54) IMAGE DISPLAY

(75) Inventor: Chun-Fu Lu, Hsinchu City (TW)

(73) Assignee: INDUSTRIAL TECHNOLOGY RESEARCH INSTITUTE, Hsinchu (TW)

(21) Appl. No.: 13/152,290

(22) Filed: Jun. 3, 2011

Related U.S. Application Data
(60) Provisional application No. 61/353,223, filed on Jun. 10, 2010.

(30) Foreign Application Priority Data
Jul. 14, 2010 (TW) 99123106

(51) Int. Cl. G02B 27/22

(52) U.S. Cl. 359/463; 359/462

(57) ABSTRACT

An image display adapted to provide a 3D image is provided. The image display includes an image displaying module, an image dividing unit, and a plurality of micro-optical structures. The image displaying module is adapted to emit a light beam including a left eye beam and a right eye beam, and the image displaying module has a displaying area. The image dividing unit is disposed on the transmission path of the light beam for dividing the left eye beam and the right eye beam from each other. The micro-optical structures are dispersed and disposed on part of the transmission path of the light beam, wherein a ratio calculated by dividing a projection area of the micro-optical structures orthogonally projected on the displaying area by the displaying area ranges from 5% to 85%.

### CROSS-REFERENCE TO RELATED APPLICATION

This application claims the priority benefits of U.S. provisional application Ser. No. 61/353,223, filed on Jun. 10, 2010 and Taiwan application serial no. 99123106, filed on Jul. 14, 2010. The entirety of each of the above-mentioned patent applications is hereby incorporated by reference herein and made a part of this specification.

### TECHNICAL FIELD

The disclosure relates to an image display.

### BACKGROUND

Along with the progress of display technology, more realistic, more immediate, more vivid, and finer displaying effect is achieved, so as to bring users fresh, vivid, and surprised visual experience. In recent years, stereoscopic displaying technology has a trend to spread from theatres to home life. As a result, stereoscopic displays or stereoscopic TVs are competitively researched and developed by international display manufacturers.

When watching a 3-dimensional (3D) film by a conventional stereoscopic displaying technology, a user wears special glasses to respectively filter out left eye images and right eye images, so that the left eye views only the left eye images and the right eye views only the right eye images. As a result, a 3D vision is generated in the brain of the user. However, it is not convenient to wear the special glasses. For example, for the user wearing glasses for nearsightedness or farsightedness, extra special glasses causes that the bridge of the nose and the ears carry the weight of two pairs of glasses so as to generate discomfort. Moreover, the size of the glasses for nearsightedness or farsightedness usually does not match that of the special glasses, so that the special glasses are usually not centrally located or easy to fall off.

Therefore, autostereoscopic displaying technology is achieved to overcome the inconvenience of wearing the special glasses. A conventional autostereoscopic displaying technology employs a parallax barrier or a lenticular film to divide a left eye image light and a right eye image light. In this way, even though the user does not wear the special glasses, the left eye also views only the left eye image, and the right eye also views only the right eye image, so that a 3D vision is generated in the brain of the user through the left eye image and the right eye image.

However, an image divider such as the parallax barrier or the lenticular film usually has periodical structures, and the pixel array of a display panel also has periodical structures. As a result, when the image divider is superimposed on the display panel, moiré is easy to occur, so that the image frame is not uniform. Moreover, a general display showing 2-dimensional images also has the problem of moiré due to the periodicity of pixels and the periodical structures of other optical films.

### SUMMARY

An image display adapted to provide a 3D image is introduced herein. The image display comprises an image displaying module, an image dividing unit, and a plurality of micro-optical structures. The image displaying module is adapted to emit a light beam comprising a left eye beam and a right eye beam, and the image displaying module has a displaying area. The image dividing unit is disposed on the transmission path of the light beam for dividing the left eye beam and the right eye beam from each other. The micro-optical structures are dispersed and disposed on part of the transmission path of the light beam, wherein a ratio calculated by dividing a projection area of the micro-optical structures orthogonally projected on the displaying area by the displaying area ranges from 5% to 85%.

An image display adapted to provide a two-dimensional image is also introduced herein. The image display comprises a light emitting unit, an image displaying unit, and a plurality of micro-optical structures. The light emitting unit is adapted to emit an illumination beam. The image displaying unit is disposed on the transmission path of the illumination beam and adapted to convert the illumination beam into an image beam, and the image displaying unit has a displaying area. The micro-optical structures are dispersed and disposed on part of at least one of the transmission paths of the illumination beam and the image beam, wherein a ratio calculated by dividing a projection area of the micro-optical structures orthogonally projected on the displaying area by the displaying area ranges from 5% to 85%, and the micro-optical structures are randomly distributed.

Several exemplary embodiments accompanied with figures are described in detail below to further describe the disclosure in details.

### BRIEF DESCRIPTION OF THE DRAWINGS

The accompanying drawings are comprised to provide further understanding, and are incorporated in and constitute a part of this specification. The drawings illustrate exemplary embodiments and, together with the description, serve to explain the principles of the disclosure.

FIG. 1A is a local schematic cross-sectional view of an image display according to an exemplary embodiment.

FIG. 1B is a local schematic front view of the image dividing unit, the micro-optical structures, and the pixels in FIG. 1A.

FIG. 2 is a local schematic cross-sectional view of an image displaying unit, an image dividing unit, and micro-optical structures of an image display according to another exemplary embodiment.

FIG. 3 is a local schematic cross-sectional view of an image displaying unit, an image dividing unit, and micro-optical structures of a image display according to still another exemplary embodiment.

FIG. 4 is a local schematic cross-sectional view of an image displaying unit, an image dividing unit, and micro-optical structures of an image display according to yet another exemplary embodiment.

FIG. 5 is a local schematic cross-sectional view of an image displaying unit, an image dividing unit, and micro-optical structures of an image display according to yet still another exemplary embodiment.

FIG. 6 is a local schematic cross-sectional view of an image displaying unit, an image dividing unit, and micro-optical structures of an image display according to yet still another exemplary embodiment.

FIG. 7 is a local schematic cross-sectional view of an image displaying unit, an image dividing unit, and micro-optical structures of an image display according to yet still another exemplary embodiment.

FIG. 8 is a local schematic cross-sectional view of an image display according to yet still another exemplary embodiment.

FIG. 9 is a local schematic cross-sectional view of an image display according to yet still another exemplary embodiment.

FIG. 10 is a local schematic cross-sectional view of an image display according to yet still another exemplary embodiment.

FIG. 11 is a local schematic front view of the image dividing unit, the micro-optical structures, and the pixels of an image display according to yet still exemplary embodiment.

FIG. 12 is a local schematic front view of the image dividing unit, the micro-optical structures, and the pixels of an image display according to yet still exemplary embodiment.

FIG. 13 is a local schematic cross-sectional view of an image display according to yet still exemplary embodiment.

FIG. 14 is a local schematic cross-sectional view of an image display according to yet still exemplary embodiment.

### DETAILED DESCRIPTION OF DISCLOSED EMBODIMENTS

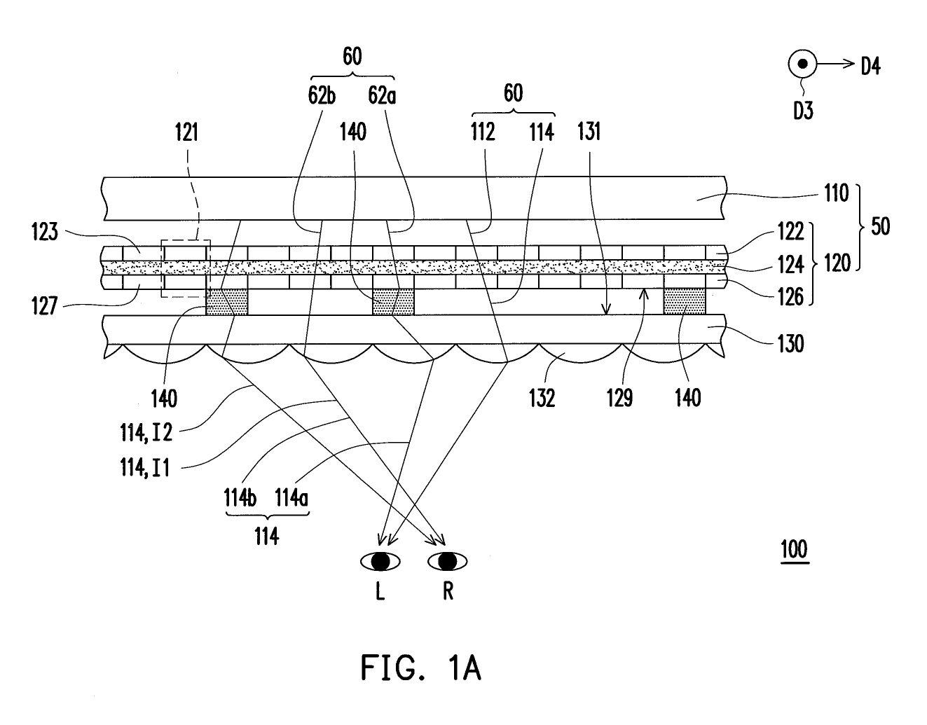

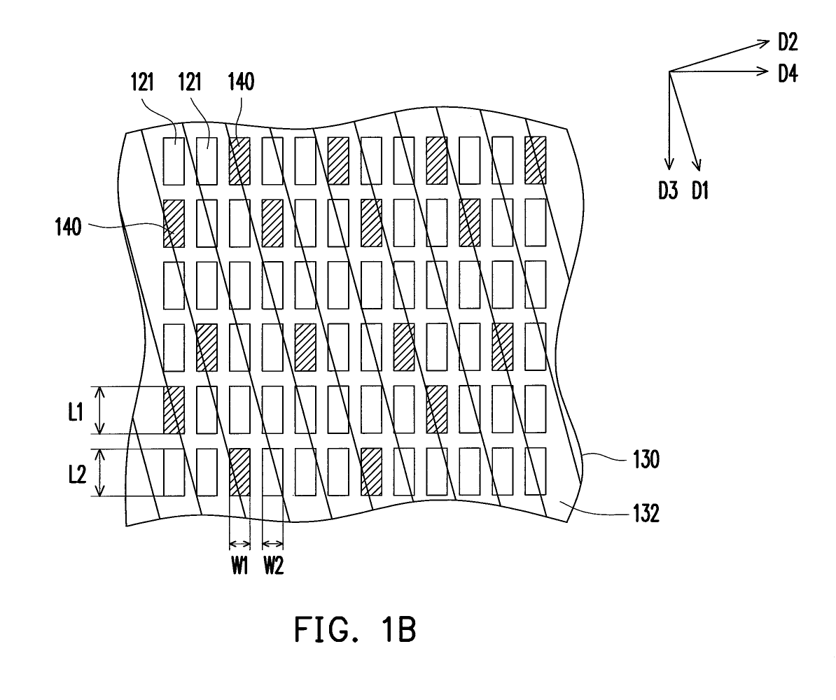

FIG. 1A is a local schematic cross-sectional view of an image display according to an exemplary embodiment. FIG. 1B is a local schematic front view of the image dividing unit, the micro-optical structures, and the pixels in FIG. 1A. Referring to FIGS. 1A and 1B, the image display 100 according to this embodiment is adapted to provide a 3D image sensed by a left eye L and a right eye R of a user. In this embodiment, the image display 100 is a parallax image display, for example. The image display 100 comprises an image displaying module 50, an image dividing unit 130, and a plurality of micro-optical structures 140. The image displaying module 50 is adapted to emit a light beam 60 comprising a left eye beam 62a and a right eye beam 62b. The image dividing unit 130 is disposed on the transmission path of the light beam 60 for dividing the left eye beam 62a and the right eye beam 62b from each other. For example, the image dividing unit 130 makes the left eye beam 62a travel to the left eye L, and makes the right eye beam 62b travel to the right eye R. That is to say, the image display 100 may be a three-dimensional image display. In another embodiment, the image dividing unit 130 may be a switchable image dividing unit to switch the image display 100 between a three-dimensional (3D) image function and a two-dimensional (2D) image function, such that the image display may be a 2D/3D switchable image display. The micro-optical structures 140 are dispersed and disposed on part of the transmission path of the light beam 60.

In this embodiment, the image displaying module 50 includes a light emitting unit 110 and an image displaying unit 120. The light emitting unit 110 is adapted to emit an illumination beam 112. In this embodiment, the emitting unit 110 is a backlight module, for example, a direct type backlight module or a side incident type backlight module.

The image displaying unit 120 is disposed on the transmission path of the illumination beam 112 and adapted to convert the illumination beam 112 into an image beam 114. The image beam 114 comprises a left eye image beam 114a and a right eye image beam 114b. In this embodiment, the light beam 60 comprises the illumination beam 112 and the image beam 114. Moreover, in this embodiment, the image displaying unit 120 is a liquid crystal panel comprising an active device array substrate 122, a liquid crystal layer 124, and an opposite substrate 126. The liquid crystal layer 124 is disposed between the active device array substrate 122 and the opposite substrate 126. The active device array substrate 122 is, for example, a thin-film-transistor (TFT) substrate and comprises a plurality of pixels 123 arranged in an array. The liquid crystal layer 124 comprises liquid crystal molecules. The opposite substrate 126 is, for example, a color filter substrate and comprises a plurality of color filtering units 127 arranged in an array. The color filtering units 127 respectively corresponds to the pixels 123. In this embodiment, the color filtering units 127 comprise red filtering units, green filtering units, and blue filtering units. Each color filtering unit 127, the corresponding pixel 123, and the portion of the liquid crystal layer 124 between the color filtering unit 127 and the corresponding pixel 123 form a pixel 121 of the image displaying unit 120. In addition, the image displaying unit 120 has a displaying area, for example, the active area of the liquid crystal panel for showing a whole frame.

The image dividing unit 130 is disposed on one of the transmission path of the illumination beam 112 and the transmission path of the image beam 114. In this embodiment, the image dividing unit 130 is disposed on the transmission path of the image beam 114. The image dividing unit 130 divides the left eye image beam 114a and the right eye image beam 114b from each other. For example, the image dividing unit 130 makes the left eye image beam 114a travel to the left eye L, and makes the right eye image beam 114b travel to the right eye R. In this embodiment, the image dividing unit 130 is, for example, a lenticular film, and comprises a plurality of rod-shaped lenticulars 132. Each of the rod-shaped lenticulars 132 extends along a first direction D1, and the rod-shaped lenticulars 132 are arranged along a second direction D2 different from the first direction D1. In this embodiment, the pixels 121 of the image displaying unit 120 are arranged in a plurality of columns along a third direction D3 and in a plurality of rows along a fourth direction D4. The third direction D3 may be perpendicular to the fourth direction D4. In this embodiment, the first direction D1 is inclined with respect to the third direction D3, the second direction D2 is inclined with respect to the fourth direction D4, and the first direction D1 is perpendicular to the second direction D2. However, in other embodiments, each of the rod-shaped lenticulars 132 may extends along the third direction D3, and the rod-shaped lenticulars 132 may be arranged along the fourth direction D4.

The micro-optical structures 140 is dispersed and disposed on part of at least one of the transmission path of the illumination beam 112 and the transmission path of the image beam 114. In this embodiment, the micro-optical structures 140 is dispersed and disposed on the transmission path of the image beam 114, and disposed between the image displaying unit 120 and the image dividing unit 130. Additionally, a ratio calculated by dividing a projection area A_{P} of the micro-optical structures 140 orthogonally projected on the displaying area of the image displaying unit 120 by this displaying area A_{D} ranges from 5% to 85%. That is, 5%≦A_{P}/A_{D}≦85%.

In this embodiment, the micro-optical structures 140 comprise a light transmissive material having a refractive index different from the refractive index of air. The micro-optical structures 140 may comprise a phase retarding material. The phase retarding material is, for example, a birefringent material. In this way, the phase of the image beam I2 passing through the micro-optical structure 140 is delayed with respect to the phase of the image beam I1 not passing through the micro-optical structure 140. In other words, after the image beam I2 passes through the micro-optical structure 140, the image beam I2 has a phase difference Δλ from the image beam I1. As a result, the image beam I2 after passing through the micro-optical structure 140 interferes with the image beam I1 not passing through the micro-optical structure 140, such that the moiré caused by the periodicity of the pixels 121 and the periodicity of the rod-shaped lenticulars 132 are reduced. In other embodiments, the micro-optical structures 140 may have a light-transmissive material with a single refractive index.

In this embodiment, the micro-optical structures 140 are randomly distributed on the surface 129 of the image displaying unit 120 and on the surface 131 of the image dividing unit 130. The random distribution of the micro-optical structures 140 further reduces the moiré caused by the periodicity of the pixels 121 and the periodicity of the rod-shaped lenticulars 132. Moreover, in this embodiment, the scale of the micro-optical structure 140 is greater than ⅓ time of the size of the pixel 121 and less than 5 times of the size of the pixel 121. The scale of the micro-optical structure 140 is, for example, the largest width of the micro-optical structure 140 parallel to the surface 129, and the size of the pixel 121 is, for example, the largest width of the pixel 121 parallel to the surface 129. In this embodiment, a width W1 of the micro-optical structure 140 is substantially or about equal to a width W2 of the pixel 121 of the image displaying unit 120. Besides, in this embodiment, a length L1 of the micro-optical structure 140 is substantially equal to a length L2 of the pixel 121 of the image displaying unit 120.

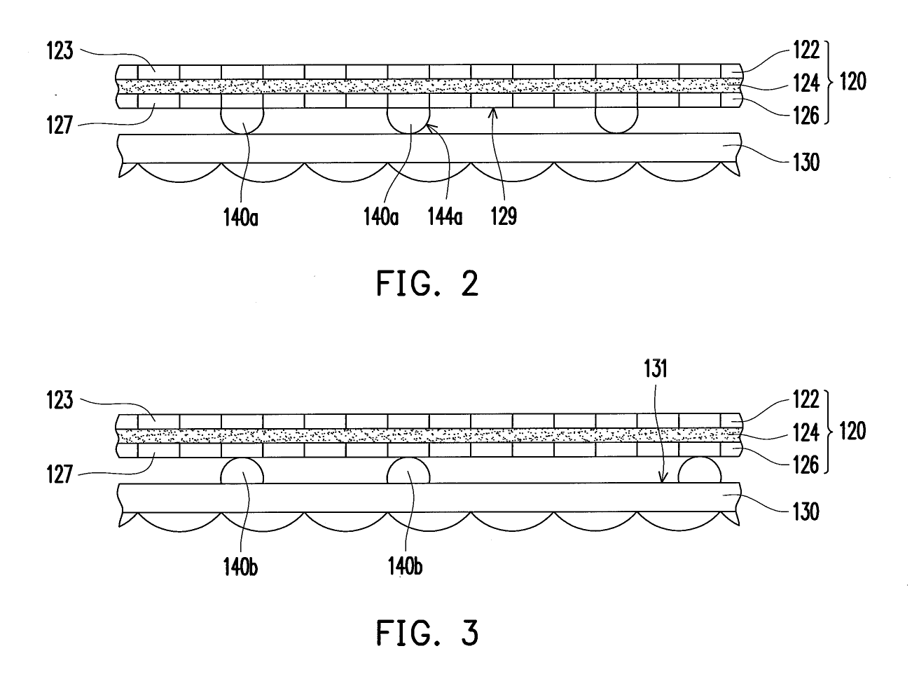

FIG. 2 is a local schematic cross-sectional view of an image displaying unit, an image dividing unit, and micro-optical structures of an image display according to another exemplary embodiment. Referring to FIG. 2, the image display according to this embodiment is similar to the image display 100 shown in FIG. 1A, and the difference therebetween is as follows. In the image display 100 in FIG. 1A, the micro-optical structures 140 are disposed on both the surface 129 of the image displaying unit 120 and the surface 131 of the image dividing unit 130. However, in this embodiment, micro-optical structures 140a are disposed on the surface 129 of the image displaying unit 120. For example, the micro-optical structures 140a are protrusions on the surface 129 of the image displaying unit 120. The material of the micro-optical structures 140a may be the same as that of the micro-optical structures 140 in FIG. 1A or those materials mentioned hereinbefore for the micro-optical structures 140. The micro-optical structures 140a may be formed by screen printing, ink jet printing, transfer printing, or other adhering processes. In other embodiments, the micro-optical structures 140a may be protrusions on a surface of at least one of the light emitting unit 110 (referring to FIG. 1A), the image displaying unit 120, and the image dividing unit 130. In this embodiment, the micro-optical structure 140a has a smooth surface 144a. However, in other embodiment, the micro-optical structure may have a rough surface, or have both a rough surface and a smooth surface.

FIG. 3 is a local schematic cross-sectional view of an image displaying unit, an image dividing unit, and micro-optical structures of a image display according to still another exemplary embodiment. Referring to FIG. 3, the image display according to this embodiment is similar to the image display according to FIG. 2, and the difference therebetween is as follows. In this embodiment, micro-optical structures 140b are disposed on the surface 131 of the image dividing unit 130. For example, the micro-optical structures 140b are protrusions on the surface 131 of the image dividing unit 130. The material of the micro-optical structures 140b may be the same as that of the micro-optical structures 140 in FIG. 1A or those materials mentioned hereinbefore for the micro-optical structures 140.

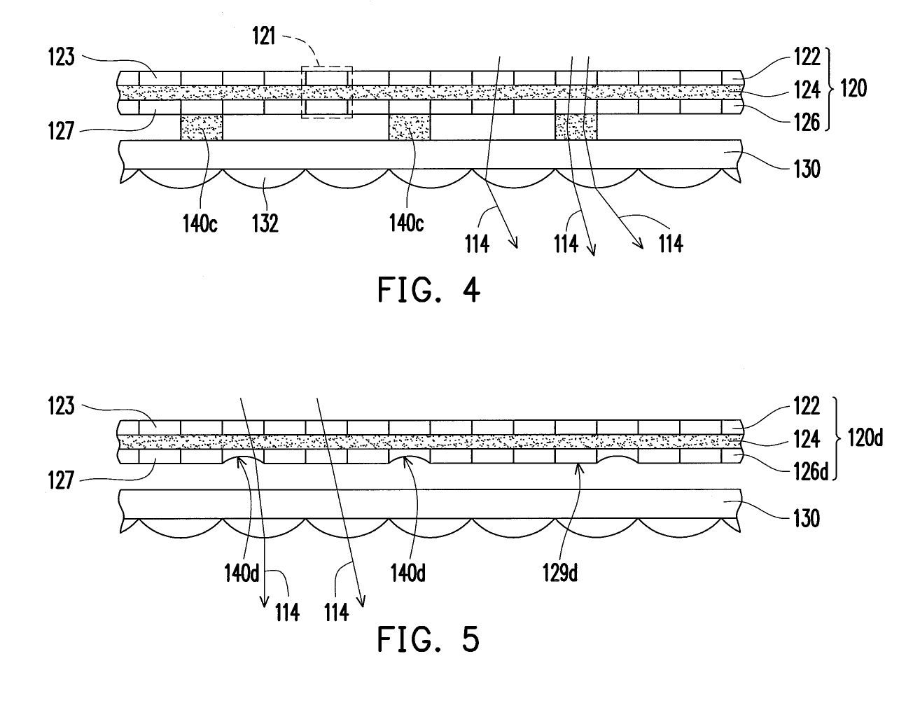

FIG. 4 is a local schematic cross-sectional view of an image displaying unit, an image dividing unit, and micro-optical structures of an image display according to yet another exemplary embodiment. Referring to FIG. 4, the image display according to this embodiment is similar to the image display 100 shown in FIG. 1A, and the difference therebetween is as follows. In this embodiment, micro-optical structures 140c comprise a light diffusing material, for example, silicon dioxide. The light diffusing material scatters the image beam 114, such that the image beam 114 scattered by the micro-optical structures 140c and the image beam 114 not scattered by the micro-optical structures 140c has not only phase difference but also travelling direction difference therebetween, thereby further reducing the moiré caused by the periodicity of the pixels 121 and the periodicity of the rod-shaped lenticulars 132.

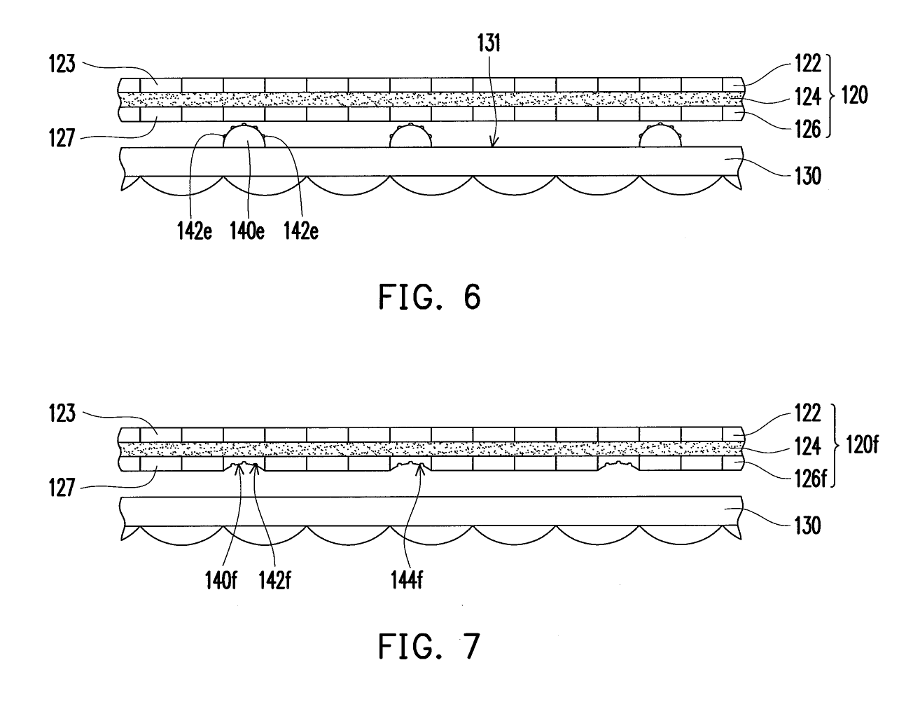

FIG. 5 is a local schematic cross-sectional view of an image displaying unit, an image dividing unit, and micro-optical structures of an image display according to yet still another exemplary embodiment. Referring to FIG. 5, the image display according to this embodiment is similar to the image display 100 shown in FIG. 1A, and the difference therebetween is as follows. In this embodiment, micro-optical structures 140d are recesses at a surface of the image displaying unit 120d. In detail, the opposite substrate 126d has recesses at the surface of the opposite substrate 126d facing the image dividing unit 130. In this embodiment, the recesses have curved concave surfaces, such that the image beam passing through the micro-optical structures 140d and the image beam not passing through the micro-optical structures 140d have not only phase difference but also travelling direction difference therebetween. In this embodiment, the recesses may be formed by sand blasting, chemical etching, laser cutting, or other etching processes.

In other embodiments, the micro-optical structures 140d are recesses at a surface of at least one of the light emitting unit 110, the image displaying unit 120, and the image dividing unit 130, referring to FIG. 1A.

FIG. 6 is a local schematic cross-sectional view of an image displaying unit, an image dividing unit, and micro-optical structures of an image display according to yet still another exemplary embodiment. Referring to FIG. 6, the image display according to this embodiment is similar to the image display according to FIG. 3, and the difference therebetween is as follows. In this embodiment, micro-optical structures 140e are protrusions on the surface 131 of the image dividing unit 130, and each of the micro-optical structures 140e has a plurality of scattering particles 142e on the surface thereof. The scattering particles 142e scatter the image beam such that the moiré is further reduced. The material of the scattering particles 142e is, for example, silicon dioxide, titanium dioxide, or any other suitable material.

FIG. 7 is a local schematic cross-sectional view of an image displaying unit, an image dividing unit, and micro-optical structures of an image display according to yet still another exemplary embodiment. Referring to FIG. 7, the image display according to this embodiment is similar to the image display according to FIG. 5, and the difference therebetween is as follows. In this embodiment, micro-optical structures 140f of this embodiment is recesses of the image displaying unit 120f, and each of the recesses has a rough surface 144f. For example, each of the recesses has a plurality of sub-recesses 142f which scatter the image beam, such that the moiré is further reduced. In other embodiments, each of the recesses may have a plurality of sub-protrusions to replace the sub-recesses.

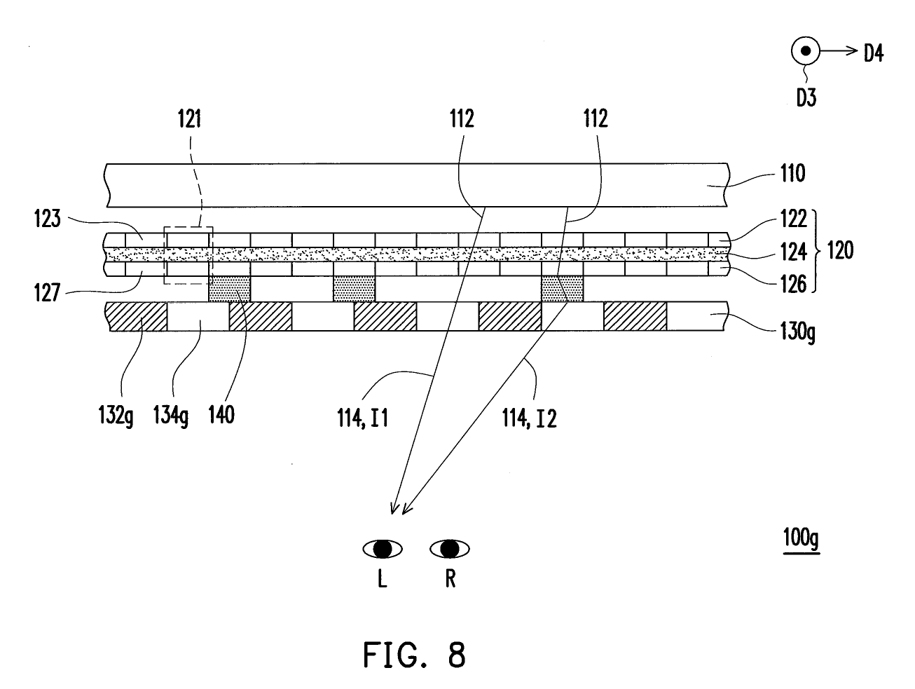

FIG. 8 is a local schematic cross-sectional view of an image display according to yet still another exemplary embodiment. Referring to FIG. 8, the image display 100g according to this embodiment is similar to the image display 100 in FIG. 1A, and the difference therebetween is as follows. In the image display 100g according to this embodiment, the image dividing unit 130g comprises a plurality of stripe-shaped barriers 132g. Each of the stripe-shaped barriers 132g extends along the third direction D3, and the stripe-shaped barriers 132g are arranged along a fourth direction D4. The stripe-shaped barriers 132g are parallax barriers which divide the image beam 114 into a left eye image beam travelling to the left eye L and a right eye image beam travelling to the right eye R, and the light transmissive regions 134g among the stripe-shaped barriers 132g allow the image beam 114 to pass through. In other embodiments, each stripe-shaped barrier 132g may extend along the first direction D1 shown in FIG. 1B like what the rod-shaped lenticular 132 does, and the strip-shaped barriers 132g may be arranged along the second direction D2 shown in FIG. 1B like what the rod-shaped lenticulars 132 do.

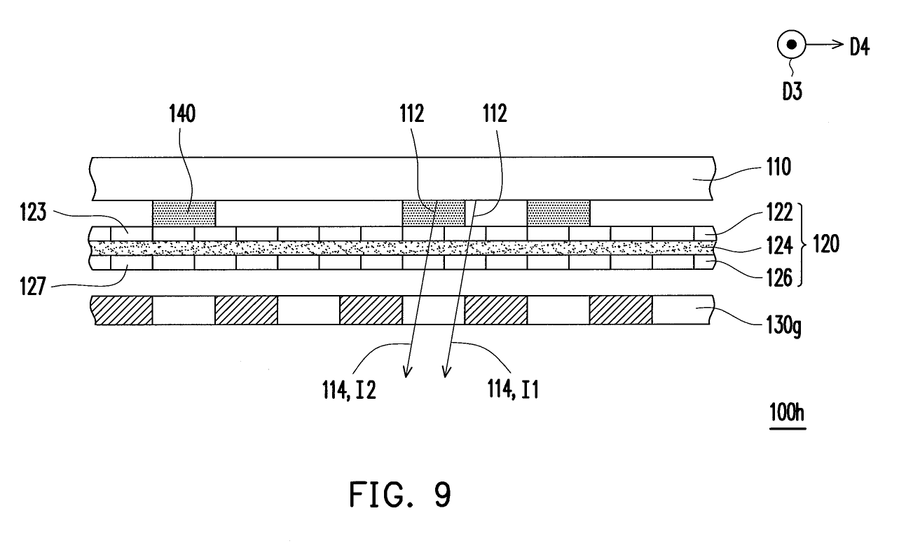

FIG. 9 is a local schematic cross-sectional view of an image display according to yet still another exemplary embodiment. Referring to FIG. 9, the image display 100h according to this embodiment is similar to the image display 100g in FIG. 8, and the difference therebetween is as follows. In the image display 100h of this embodiment, the micro-optical structures 140 are disposed between the light emitting unit 110 and the image displaying unit 120. The illumination beam 112 passing through the micro-optical structure 140 and the illumination beam 112 not passing through the micro-optical structure 140 have phase difference therebetween, such that the image beam I2 and the image beam I1 have phase difference therebetween.

In other embodiments, the image dividing unit 130g may be removed from the image display 100h to form a two-dimensional image display, and the micro-optical structures 140 may be disposed on part of the transmission path of at least one of the illumination beam 112 and the image beam 114. For example, the micro-optical structures 140 may be disposed on the light emitting unit 110, on the surface of the image displaying unit 120 facing the light emitting unit 110, on both of the light emitting unit 110 and the surface of the image displaying unit 120 facing the light emitting unit 110, or on the surface of the image displaying unit 120 facing away from the light emitting unit 110. The micro-optical structures 140 may also be replaced by surface protrusions, surface recesses, or micro-optical structures with other material, as described in other embodiments.

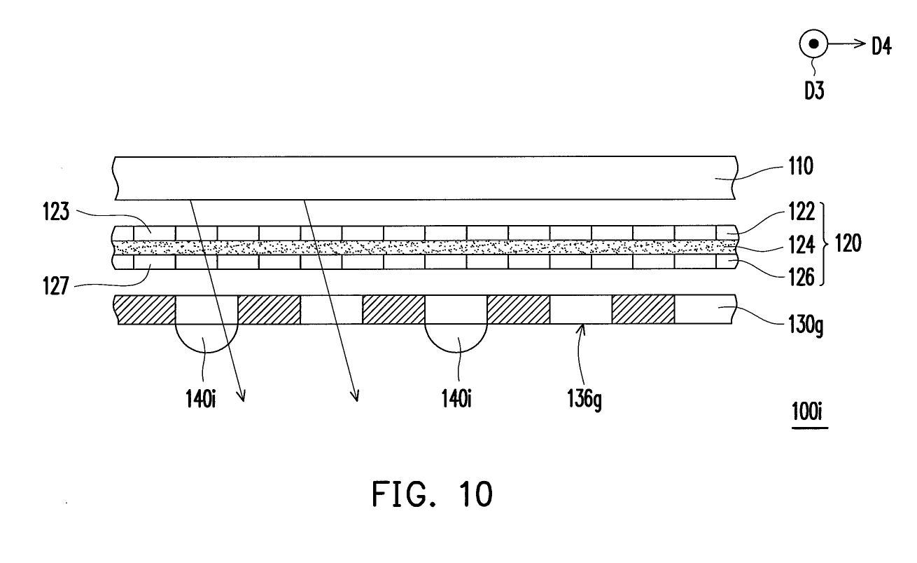

FIG. 10 is a local schematic cross-sectional view of an image display according to yet still another exemplary embodiment. Referring to FIG. 10, the image display 100i according to this embodiment is similar to the image display 100g in FIG. 8, and the difference therebetween is as follows. In the image display 100i, micro-optical structures 140i are disposed between the light dividing unit 130g and the left and right eyes L and R of the user. In this embodiment, the micro-optical structures 140i are protrusions on the surface 136g of the light dividing unit 130g. The material of the micro-optical structures 140i may be the same as that of the micro-optical structures 140 in FIG. 1A or those materials for the micro-optical structures 140 mentioned hereinbefore.

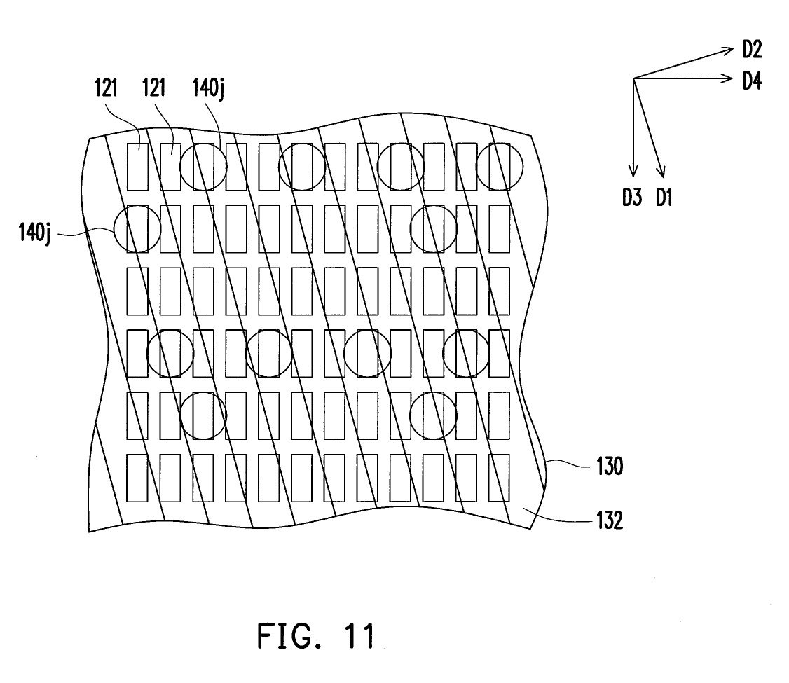

FIG. 11 is a local schematic front view of the image dividing unit, the micro-optical structures, and the pixels of an image display according to yet still exemplary embodiment. Referring to FIG. 11, the image display according to this embodiment is similar to the 3D imaged display according to FIG. 1B, and the difference therebetween is as follows. The micro-optical structures 140 in FIG. 1B are rectangular-shaped. However, in this embodiment, the micro-optical structures 140j are circular-shaped as shown in FIG. 11.

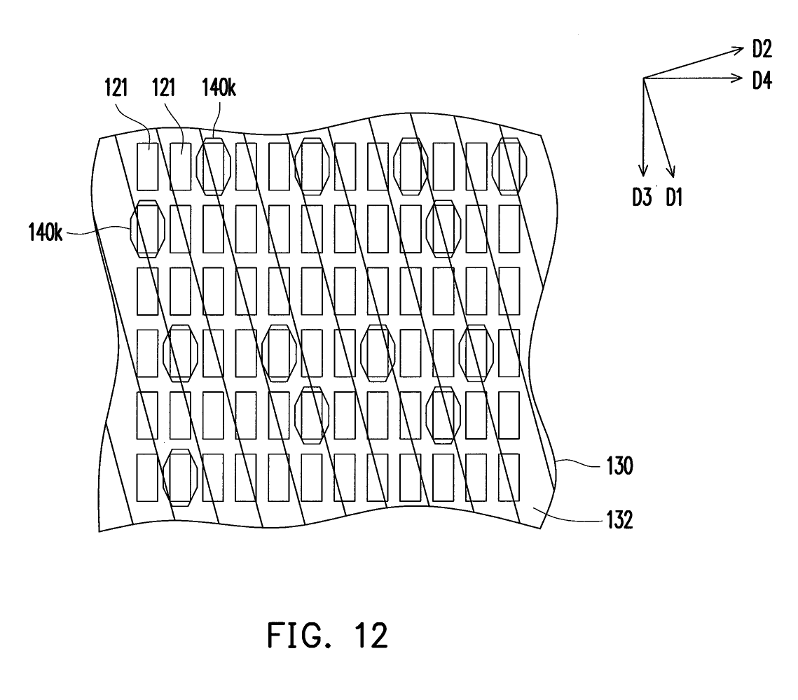

FIG. 12 is a local schematic front view of the image dividing unit, the micro-optical structures, and the pixels of an image display according to yet still exemplary embodiment. Referring to FIG. 12, the image display according to this embodiment is similar to the 3D imaged display according to FIG. 1B, and the difference therebetween is as follows. In this embodiment, the micro-optical structures 140k are polygonal-shaped as shown in FIG. 12. In other embodiments, the micro-optical structures may be shaped in any other geometric form. Moreover, the micro-optical structures 140d (i.e. the recesses) in FIG. 5 may be circular recesses, rectangular recesses, polygonal recesses, or recesses shaped in any other geometric forms.

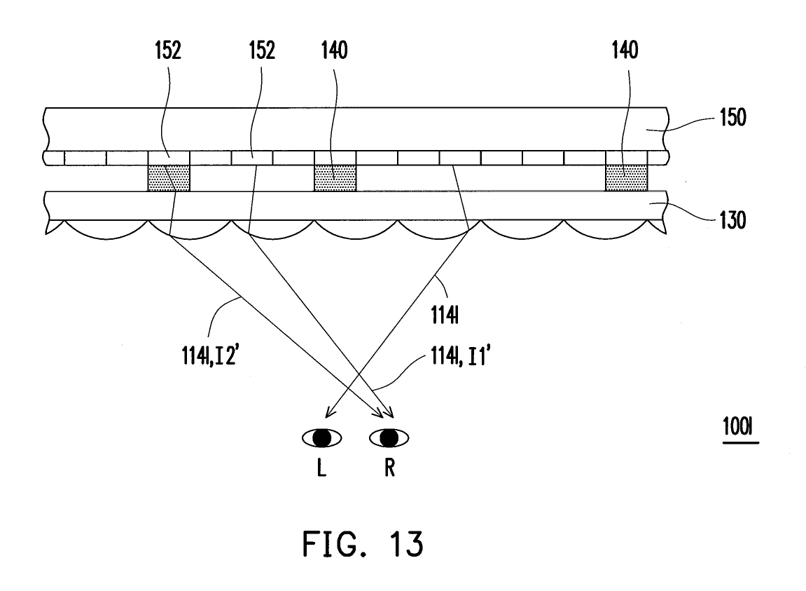

FIG. 13 is a local schematic cross-sectional view of an image display according to yet still exemplary embodiment. Referring to FIG. 13, the image display 100l according to this embodiment is similar to the image display 100 in FIG. 1A, and the difference therebetween is as follows. In the image display 100l according to this embodiment, the light emitting unit 110 and the image displaying unit 120 in FIG. 1A is replaced by an image displaying module 150. In this embodiment, the image displaying module 150 is an active image displaying unit (i.e. a self-illuminating image displaying unit) which emits an image beam 114l by itself (referring to FIG. 13), but does not convert the illumination beam 112 from the light emitting unit 110 into the image beam 114 (referring to FIG. 1A). The image displaying module 150 is, for example, a light-emitting diode (LED) array display, an organic light-emitting diode (OLED) array display, a plasma display panel (PDP), a cathode ray tube (CRT), or any other active display (i.e. a self-illumination display). In this embodiment, the image displaying module 150 has a plurality of pixels 152 respectively emitting light, and the micro-optical structures 140 are disposed between the image displaying module 150 and the image dividing unit 130. The image beam I2′ passing through the micro-optical structure 140 and the image beam I1′ not passing through the micro-optical structure 140 have phase difference therebetween, such that the moiré caused by the periodicity of the image displaying module 150 and the periodicity of the image dividing unit 130 is reduced. In another embodiment, the micro-optical structure 140 may be disposed between the image dividing unit 130 and the left and right eyes L and R of the user.

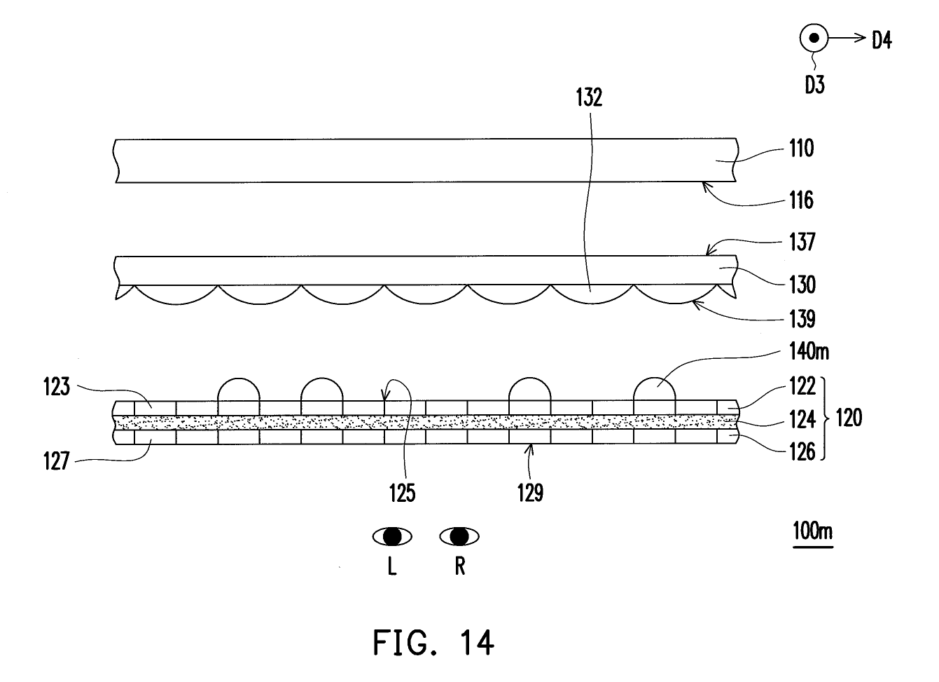

FIG. 14 is a local schematic cross-sectional view of an image display according to yet still exemplary embodiment. Referring to FIG. 14, the image display 100m according to this embodiment is similar to the image display 100 in FIG. 1A, and the difference therebetween is as follows. In the image display 100m of this embodiment, the image dividing unit 130 is disposed between the light emitting unit 110 and the image displaying unit 120. In this embodiment, micro-optical structures 140m are protrusions on the surface 125 of the image displaying unit 120. The material of the micro-optical structures 140m may be the same as the micro-optical structures 140m in FIG. 1A or those materials for the micro-optical structures 140 mentioned hereinbefore. In another embodiment, the micro-optical structures 140m may be replaced by the micro-optical structures 140 in FIG. 1A, and the micro-optical structures 140 connect the image dividing unit 130 and the image displaying unit 120. In other embodiments, the micro-optical structures 140m may be disposed between the light emitting unit 110 and the image dividing unit 130, or between the image displaying unit 120 and the left and right eyes of the user. In other embodiments, the micro-optical structures 140m may be disposed on at least one of the surface 116 of the light emitting unit 110, the surfaces 137 and 139 of the image dividing unit 130, and the surfaces 125 and 129 of the image displaying unit 120. Alternatively, the micro-optical structures may be recesses disposed on at least one of the surface 116 of the light emitting unit 110, the surfaces 137 and 139 of the image dividing unit 130, and the surfaces 125 and 129 of the image displaying unit 120.

In view of the above, since the image display according to the exemplary embodiments has dispersed micro-optical structures, and since a phase difference between the light beam passing through the micro-optical structures and the light beam not passing through the micro-optical structures is generated, the moiré of the image display is effectively reduced.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. An image display adapted to provide a 3-dimensional (3D) image, the image display comprising:
an image displaying module adapted to emit a light beam comprising a left eye beam and a right eye beam, wherein the image displaying module has a displaying area;
an image dividing unit disposed on the transmission path of the light beam for dividing the left eye beam and the right eye beam from each other; and
a plurality of micro-optical structures dispersed and disposed on part of the transmission path of the light beam, wherein a ratio calculated by dividing a projection area of the micro-optical structures orthogonally projected on the displaying area by the displaying area ranges from 5% to 85%.

2. The image display according to claim 1, wherein the micro-optical structures comprising a light transmissive material having a refractive index different from a refractive index of air.

3. The image display according to claim 1, wherein the micro-optical structures comprising a light diffusing material.

4. The image display according to claim 1, wherein the micro-optical structures comprising a phase retarding material.

5. The image display according to claim 4, wherein the phase retarding material is a birefringent material.

6. The image display according to claim 1, wherein the image displaying module comprises:
a light emitting unit adapted to emit an illumination beam; and
an image displaying unit disposed on the transmission path of the illumination beam and adapted to convert the illumination beam into an image beam comprising a left eye image beam and a right eye image beam, wherein the image displaying unit has the displaying area, the light beam comprises the illumination beam and the image beam, the image dividing unit is disposed on part of one of the transmission path of the illumination beam and the transmission path of the image beam for dividing the left eye image beam and the right eye image beam from each other, the micro-optical structures are dispersed and disposed on part of at least one of the transmission path of the illumination beam and the transmission path of the image beam.

7. The image display according to claim 6, wherein the micro-optical structures are protrusions on a surface of at least one of the light emitting unit, the image displaying unit, and the image dividing unit.

8. The image display according to claim 6, wherein the micro-optical structures are recesses at a surface of at least one of the light emitting unit, the image displaying unit, and the image dividing unit.

9. The image display according to claim 6, wherein the micro-optical structures are disposed between the light emitting unit and the image displaying unit.

10. The image display according to claim 6, wherein the image displaying unit is disposed between the light emitting unit and the image dividing unit.

11. The image display according to claim 6, wherein the image dividing unit is disposed between the light emitting unit and the image displaying unit.

12. The image display according to claim 6, wherein the micro-optical structures are disposed between the image displaying unit and the image dividing unit.

13. The image display according to claim 1, wherein the micro-optical structures are protrusions on a surface of at least one of the image displaying module and the image dividing unit.

14. The 3D image display according to claim 1, wherein the micro-optical structures are recesses at a surface of at least one of the image displaying module and the image dividing unit.

15. The image display according to claim 1, wherein the micro-optical structures are disposed between the image displaying module and the image dividing unit.

16. The image display according to claim 1, wherein a light dividing unit is disposed between the micro-optical structures and the image displaying module.

17. The image display according to claim 1, wherein the image dividing unit is disposed beside the image displaying module.

18. The image display according to claim 1, wherein the image dividing unit comprises a plurality of stripe-shaped barriers, each of the stripe-shaped barriers extends along a first direction, and the stripe-shaped barriers are arranged along a second direction different from the first direction.

19. The image display according to claim 1, wherein the image dividing unit comprises a plurality of rod-shaped lenticulars, each of the rod-shaped lenticulars extends along a first direction, and the rod-shaped lenticulars are arranged along a second direction different from the first direction.

20. The image display according to claim 1, wherein the image displaying module comprises a plurality of pixels, and a scale of the micro-optical structure is greater than ⅓ time of a size of the pixel of the image displaying module and less than 5 times of the size of the pixel of the image displaying module.

21. The image display according to claim 1, wherein the micro-optical structures are randomly distributed.

22. The image display according to claim 1, wherein each of the micro-optical structures has a smooth surface, a rough surface, or a combination thereof.

23. The image display according to claim 1, wherein the image displaying module is an active image display unit, and the active image display unit is a light emitting diode array display, a organic light emitting diode array display, a plasma display panel, or a cathode ray tube.

24. A image display adapted to provide a two-dimensional image, the image display comprising:
a light emitting unit adapted to emit an illumination beam;
an image displaying unit disposed on the transmission path of the illumination beam and adapted to convert the illumination beam into an image beam, wherein the image displaying unit has a displaying area; and
a plurality of micro-optical structures dispersed and disposed on part of at least one of the transmission paths of the illumination beam and the image beam, wherein a ratio calculated by dividing a projection area of the micro-optical structures orthogonally projected on the displaying area by the displaying area ranges from 5% to 85%, and the micro-optical structures are randomly distributed.
